(19) United States
(12) Patent Application Publication
(10) Pub. No.: US 2013/0078501 A1
(43) Pub. Date: Mar. 28, 2013

(54) THIN TYPE BATTERY AND ENCAPSULATION STRUCTURE THEREOF

(71) Applicants: Chung-Da YANG, Miaoli County (TW); Ray Tang SUN, Miaoli County (TW)

(72) Inventors: Chung-Da YANG, Miaoli County (TW); Ray Tang SUN, Miaoli County (TW)

(73) Assignee: UER Technology Corporation, Miaoli County (TW)

(21) Appl. No.: 13/557,625

(22) Filed: Jul. 25, 2012

(30) Foreign Application Priority Data
Sep. 28, 2011 (TW) 100218178

(51) Int. Cl. H01M 2/02

(52) U.S. Cl. 429/162

(57) ABSTRACT

An encapsulation structure of a thin type battery for encapsulating a battery is provided. The battery includes a battery body and a top sealing area having a thickness smaller than that of the battery body. The encapsulation structure of a thin type battery includes a frame body and an extending wall. The frame body includes a first sidewall, a second sidewall, a third sidewall, and a fourth sidewall. Two ends of the third sidewall are connected to the first sidewall and the second sidewall, respectively. The fourth sidewall is opposite the third sidewall. Two ends of the fourth sidewall are connected to the first sidewall and the second sidewall, respectively. The extending wall is connected to one side of the first sidewall and clamped at the third sidewall and the fourth sidewall. In addition, a thin type battery is also provided.

### CROSS-REFERENCES TO RELATED APPLICATIONS

This non-provisional application claims priority under 35 U.S.C. §119(a) on Patent Application No. 100218178 filed in Taiwan, R.O.C. on 2011 Sep. 28, the entire contents of which are hereby incorporated by reference.

### BACKGROUND OF THE INVENTION

1. Technical Field

The present invention relates to a battery and an encapsulation structure thereof, and more particularly to a thin type battery and an encapsulation structure thereof.

2. Related Art

Tablet computers and mobile phones have gradually become increasingly popular, and now have a tendency to replace conventional personal computers and even notebook computers. Such an electronic device is popular due to excellent portability and a human-centered touch interface. Ease of portability requires the device to be both light and thin.

A battery occupies a considerable weight and volume in a portable electronic device, so when the electronic device is lighter and thinner, the weight and volume of the battery is reduced correspondingly, providing greater flexibility for configuration of the other electronic components.

A common battery encapsulation structure is to pack a battery in a plastic shell body. In addition, some manufacturers encapsulate the battery in a composite material shell body formed of a metal sheet and plastic. The composite material shell body is formed by combining a metal sheet and plastic in the manner of insert molding or ultrasonic vibration.

However, the thickness of the product formed through encapsulation in this manner is the thickness of the shell body plus the thickness of the battery body, and the thickness of the shell body is limited by the inject molding technology; additionally, the characteristics of the material and cannot be reduced endlessly, so in the prior art reduction of the battery's thickness encounters a bottleneck.

### SUMMARY

In view of this, the present invention provides an encapsulation structure of a thin type battery used for encapsulating a battery. The battery includes a battery body and a top sealing area having a thickness smaller than that of the battery body. The top sealing area includes a battery terminal and a secondary protection element. The encapsulation structure of a thin type battery includes a frame body and an extending wall. The frame body includes a first sidewall, a second sidewall, a third sidewall, and a fourth sidewall. The first sidewall has a first side, a second side, and a first flange. The first side is opposite the second side. The first flange is connected to the first side and protrudes from the first sidewall. The second sidewall is opposite the first sidewall. Two ends of the third sidewall are connected to the first sidewall and the second sidewall, respectively. The third sidewall has a first clamping portion. The fourth sidewall is opposite the third sidewall. Two ends of the fourth sidewall are connected to the first sidewall and the second sidewall, respectively. The fourth sidewall has a second clamping portion. The extending wall is connected to the second side in a bendable manner. A first clamping piece and a second clamping piece are provided at two ends of the extending wall, respectively. When the first clamping piece and the second clamping piece are clamped at the first clamping portion and the second clamping portion, respectively, the extending wall and the first flange envelop the top sealing area of the battery.

In addition, the battery terminal may further be connected electrically to a circuit board, such that the battery can be connected electrically to an external electronic device through the circuit board to supply power. When the extending wall is bent to enable the first clamping piece and the second clamping piece to be clamped at the first clamping portion and the second clamping portion, respectively, a cavity is just formed between the frame body and the top sealing area. Further, the thickness of the top sealing area is smaller than that of the battery body; such a design is also called a “tortoise back” design in the industry.

In addition, the present invention also provides a thin type battery, which includes a battery, a frame body, and an extending wall. The battery includes a battery body and a top sealing area. The thickness of the top sealing area is smaller than that of the battery body. The frame body includes a first sidewall, a second sidewall, a third sidewall, and a fourth sidewall. The first sidewall has a first side, a second side, and a first flange. The first side is opposite the second side. The first flange is connected to the first side and protrudes from the first sidewall. The second sidewall is opposite the first sidewall. Two ends of the third sidewall are connected to the first sidewall and the second sidewall, respectively. The third sidewall has a first clamping portion. The fourth sidewall is opposite the third sidewall. Two ends of the fourth sidewall are connected to the first sidewall and the second sidewall, respectively. The fourth sidewall has a second clamping portion. The extending wall is connected to the second side in a bendable manner. A first clamping piece and a second clamping piece are provided at two ends of the extending wall, respectively. When the first clamping piece and the second clamping piece are clamped at the first clamping portion and the second clamping portion, respectively, the extending wall and the first flange envelop the top sealing area of the battery.

In conclusion, the present invention discards a shell body and uses a frame body and a bendable and foldable extending wall instead to encapsulate a battery to achieve the thinning effect. Holes can be further opened at the extending wall for filling epoxy resin and discharging air, so that the epoxy resin desirably seals a top sealing area of the battery and a circuit board. When the epoxy resin is cured, a highly reliable thin type battery is acquired, so the problems in the prior art are effectively mitigated.

### BRIEF DESCRIPTION OF THE DRAWINGS

The present invention will become more fully understood from the detailed description given herein below for illustration only, and thus not limitative of the present invention, wherein:

FIG. 1 is a schematic diagram (1) according to a first embodiment of the present invention;

FIG. 2 is a schematic diagram (2) according to the first embodiment of the present invention;

FIG. 3 is a schematic diagram (3) according to the first embodiment of the present invention;

FIG. 4 is a sectional view (1) along a section line AA in FIG. 3; and

FIG. 5 is a sectional view (2) along the section line AA in FIG. 3.

### DETAILED DESCRIPTION

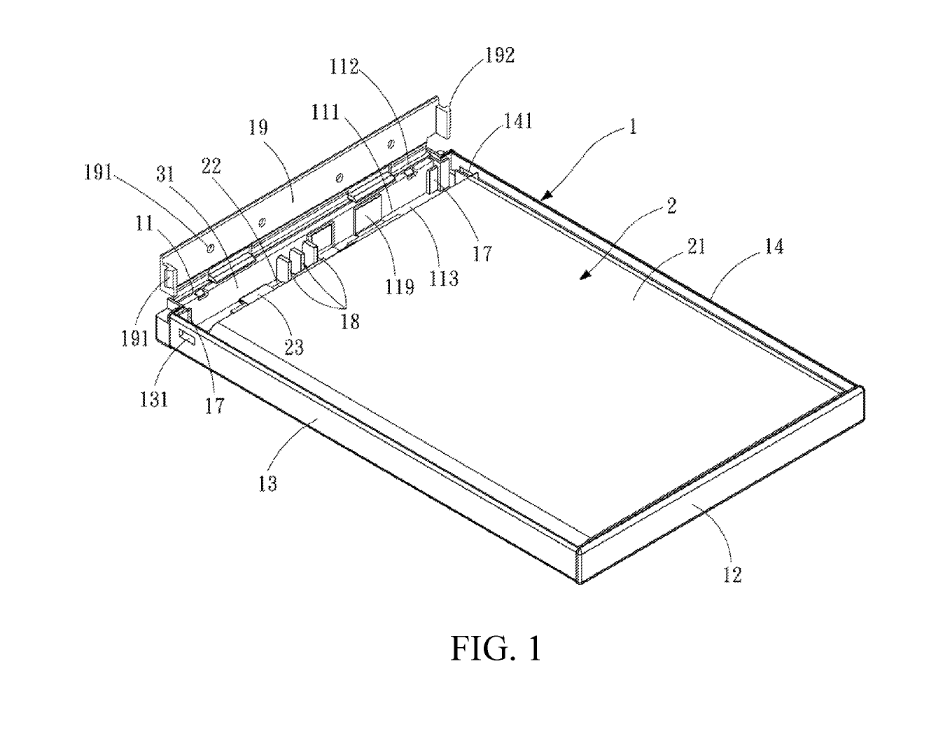

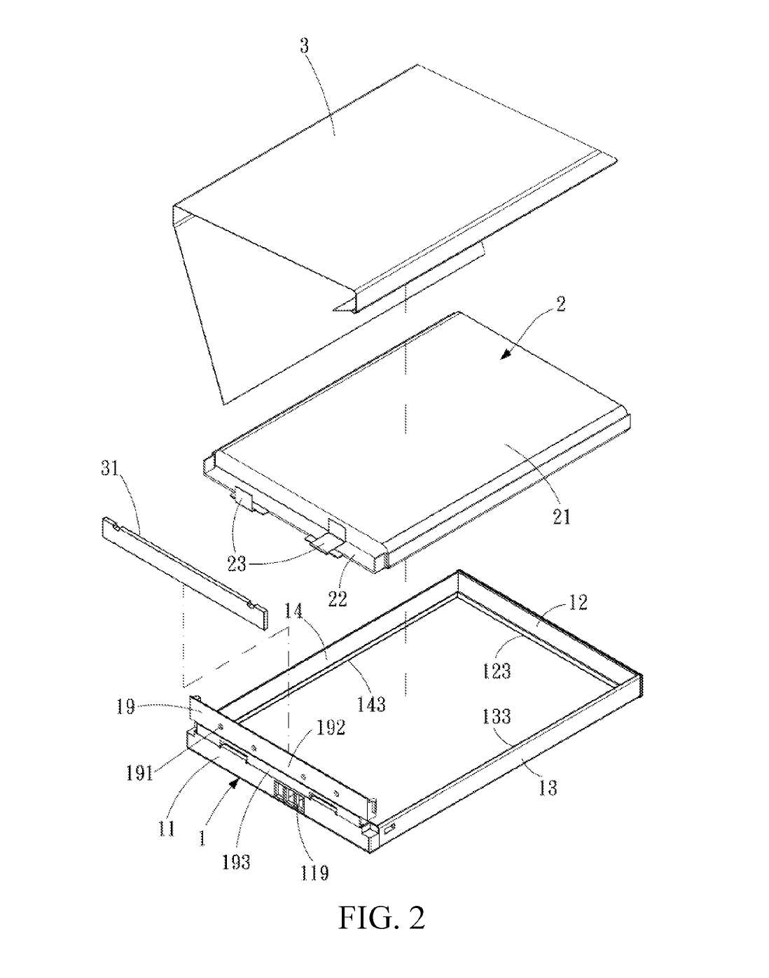

Please refer to FIG. 1 to FIG. 3, which are a schematic diagram (1), a schematic diagram (2), and a schematic diagram (3) according to a first embodiment of the present invention, in which a thin type battery and an encapsulation structure thereof are disclosed. The thin type battery includes a frame body 1, a battery 2, and an extending wall 19. The battery includes a battery body 21 and a top sealing area 22. The thickness of the top sealing area 22 is smaller than that of the battery body 21. The frame body 1 includes a first sidewall 11, a second sidewall 12, a third sidewall 13, and a fourth sidewall 14. The first sidewall 11 has a first side 111, a second side 112, and a first flange 113. The first side 111 is opposite the second side 112. The first flange 113 is connected to the first side 111 and protrudes from the first sidewall 11. The second sidewall 12 is opposite the first sidewall 11. Two ends of the third sidewall 13 are connected to the first sidewall 11 and the second sidewall 12, respectively. The third sidewall 13 has a first clamping portion 131. The fourth sidewall 14 is opposite the third sidewall 13. Two ends of the fourth sidewall 14 are connected to the first sidewall 11 and the second sidewall 12, respectively. The fourth sidewall 14 has a second clamping portion 141. The extending wall 19 is connected to the second side 112 in a bendable manner. A first clamping piece 191 and a second clamping piece 192 are provided at two ends of the extending wall 19, respectively. When the first clamping piece 191 and the second clamping piece 192 are clamped at the first clamping portion 131 and the second clamping portion 141, respectively, the extending wall 19 and the first flange 113 just envelop the top sealing area 22 of the battery 2.

Through this embodiment, the top sealing area 22 of the battery 2 is only required to butt against the first flange 113, and then the extending wall 19 is bent relative to the first sidewall 11 to enable the first clamping piece 191 and the second clamping piece 192 to be clamped at the first clamping portion 131 and the second clamping portion 141, respectively. In such a manner, the top sealing area 22 of the battery 2 is just enveloped by the extending wall 19 and the first flange 113.

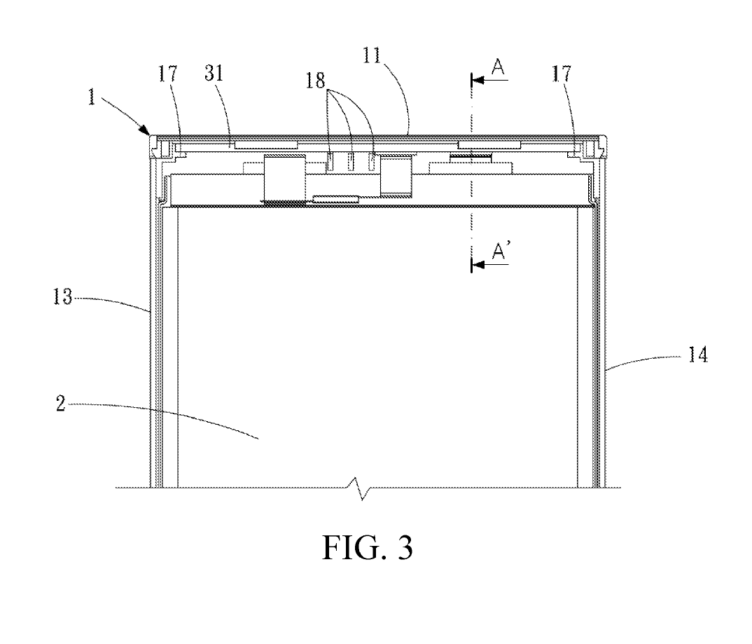

In addition, the battery 2 in this embodiment supplies power thereof to an external electronic device through the circuit board 31. The circuit board 31 is installed in a circuit board fixing seat 17 and at the same time butts against a baffle 18, as shown in FIG. 3. The first sidewall is then opened with a hole 119, so that an external electronic device can be connected to the circuit board 31 through the hole 119 to further obtain power of the battery 2.

To further avoid adverse influences on the battery 2 caused by moisture intrusion, at least one hole 191 can be opened on the extending wall 19, so that only epoxy resin or other polymer materials with insulation and moisture isolation properties need be injected in the hole 119 or holes 191 to envelop the battery terminal 23 of the battery 2, so as to effectively prevent moisture from intruding into the battery 2 and at the same time avoid short circuit between the battery terminals 23. Multiple holes 191 can be opened, so that air inside can be discharged through other holes during the process of injecting the epoxy resin.

In addition, after the battery 2 is placed in the frame body 1, an adhesive tape 3 is further wound around the frame body 1 and the battery 2, so as to further fix the battery 2 in the frame body 1.

In this embodiment, the second sidewall 12, the third sidewall 13, and the fourth sidewall 14 have a second flange 123, a third flange 133, and a fourth flange 143, respectively. The second flange 123 protrudes from the second sidewall 12 by a first distance. The third flange 133 protrudes from the third sidewall 13 by a second distance. The fourth flange 143 protrudes from the fourth sidewall 14 by a third distance. The first distance, the second distance, and the third distance are in a range of 0.5 mm to 2 mm.

As a seal rim is provided at an edge of the 2 (soft packaging cell), when the battery 2 is placed in the frame body 1, in addition to that the top sealing area 22 butts against the first flange 113, the seal rim can also butt against the second flange 123, the third flange 133, and the fourth flange 143. In such a manner, the battery 2 can be placed in the frame body 1 more securely.

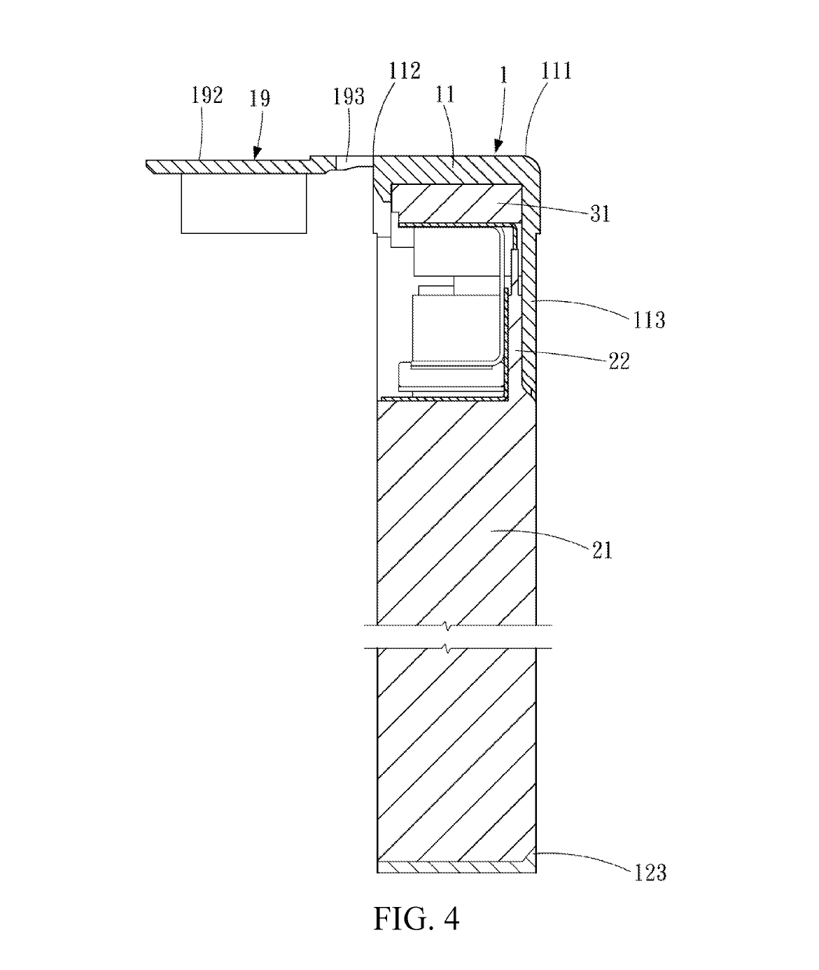

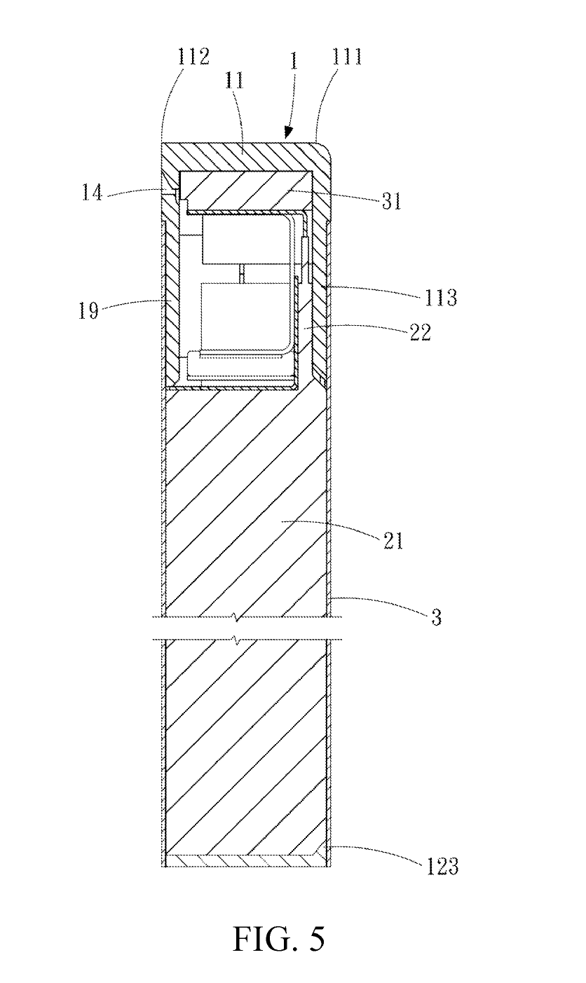

Please refer to FIG. 4 and FIG. 5, which are a sectional view (1) and a sectional view (2) along a section line AA in FIG. 3, respectively, and are used for representing aspects occurring before and after the extending wall 19 is bent, respectively. In this embodiment, the extending wall 19 includes a first region 192 and a second region 193. The thickness of the second region 193 is between one third and two thirds of the thickness of the first region 192. The extending wall 19 in this embodiment is connected to the second side 112 with the second region 193. By designing the thickness of the second region 193 to be smaller, when the extending wall 19 is bent, the compression and deformation of the material of the bendable region do not cause a bulging phenomenon to the bendable region.

In these embodiments, the frame body and the bendable and foldable extending wall are used to encapsulate a battery to achieve the thinning effect. The extending wall is further opened with a hole for filling epoxy resin and discharging air, so that the epoxy resin can desirably seal the top sealing area of the battery and the circuit board. When the epoxy resin is cured, a highly reliable thin type battery is formed.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An encapsulation structure of a thin type battery, used for encapsulating a battery, the battery comprising a battery body and a top sealing area, the thickness of the top sealing area being smaller than that of the battery body, and the battery encapsulation structure comprising:
a frame body, comprising:
a first sidewall, having a first side, a second side, and a first flange, the first side being opposite the second side, the first flange being connected to the first side and protruding from a surface of the first sidewall, and the first flange being used for butting against the top sealing area;
a second sidewall, being opposite the first sidewall;
a third sidewall, having two ends connected to the first sidewall and the second sidewall, respectively, and having a first clamping portion; and
a fourth sidewall, being opposite the third sidewall, having two ends connected to the first sidewall and the second sidewall, respectively, and having a second clamping portion; and
an extending wall, connected to the second side in a bendable manner, a first clamping piece and a second clamping piece being provided at two ends of the extending wall, respectively, the first clamping piece being used for clamping the first clamping portion, and the second clamping piece being used for clamping the second clamping portion,
wherein when the first clamping piece and the second clamping piece are clamped at the first clamping portion and the second clamping portion, respectively, the extending wall and the first flange envelop the top sealing area of the battery.

2. The encapsulation structure of a thin type battery according to claim 1, wherein the second sidewall has a second flange protruding from the second sidewall by a first distance and used for butting against the battery body.

3. The encapsulation structure of a thin type battery according to claim 2, wherein the first distance is in a range of 0.5 mm to 2 mm.

4. The encapsulation structure of a thin type battery according to claim 1, wherein the third sidewall has a third flange protruding from the third sidewall by a second distance and used for butting against the battery body.

5. The encapsulation structure of a thin type battery according to claim 4, wherein the second distance is in a range of 0.5 mm to 2 mm.

6. The encapsulation structure of a thin type battery according to claim 1, wherein the fourth sidewall has a fourth flange protruding from the fourth sidewall by a third distance and used for butting against the battery body.

7. The encapsulation structure of a thin type battery according to claim 6, wherein the third distance is in a range of 0.5 mm to 2 mm.

8. The encapsulation structure of a thin type battery according to claim 1, wherein the extending wall comprises a first region and a second region, the thickness of the second region is between one third and two thirds of the thickness of the first region, and the extending wall is connected to the second side with the second region.

9. The encapsulation structure of a thin type battery according to claim 1, wherein the first sidewall has at least one hole.

10. The encapsulation structure of a thin type battery according to claim 1, wherein the extending wall has at least one hole.

11. A thin type battery, comprising:
a battery, comprising a battery body and a top sealing area, the thickness of the top sealing area being smaller than that of the battery body;
a frame body, comprising:
a first sidewall, having a first side, a second side, and a first flange, the first side being opposite the second side, the first flange being connected to the first side and protruding from the first sidewall, and the first flange being used for butting against the top sealing area;
a second sidewall, being opposite the first sidewall;
a third sidewall, having two ends connected to the first sidewall and the second sidewall, respectively, and having a first clamping portion; and
a fourth sidewall, being opposite the third sidewall, having two ends connected to the first sidewall and the second sidewall, respectively, and having a second clamping portion; and
an extending wall, connected to the second side in a bendable manner, a first clamping piece and a second clamping piece being provided at two ends of the extending wall, respectively, the first clamping piece being used for clamping the first clamping portion, and the second clamping piece being used for clamping the second clamping portion,
wherein when the first clamping piece and the second clamping piece are clamped at the first clamping portion and the second clamping portion, respectively, the extending wall and the first flange envelop the top sealing area of the battery.

12. The thin type battery according to claim 11, wherein the second sidewall has a second flange protruding from the second sidewall by a first distance and used for butting against the battery body.

13. The thin type battery according to claim 12, wherein the first distance is in a range of 0.5 mm to 2 mm.

14. The thin type battery according to claim 11, wherein the third sidewall has a third flange protruding from the third sidewall by a second distance and used for butting against the battery body.

15. The thin type battery according to claim 14, wherein the second distance is in a range of 0.5 mm to 2 mm.

16. The thin type battery according to claim 11, wherein the fourth sidewall has a fourth flange protruding from the fourth sidewall by a third distance and used for butting against the battery body.

17. The thin type battery according to claim 16, wherein the third distance is in a range of 0.5 mm to 2 mm.

18. The thin type battery according to claim 11, wherein the extending wall comprises a first region and a second region, the thickness of the second region is between one third and two thirds of the thickness of the first region, and the extending wall is connected to the first side with the second region.

19. The thin type battery according to claim 11, wherein the first sidewall has at least one hole.

20. The thin type battery according to claim 11, wherein the extending wall has at least one hole.
